(19) United States
(12) Patent Application Publication
(10) Pub. No.: US 2026/0312534 A1
(43) Pub. Date: Oct. 8, 2026

(54) CONNECTION STRUCTURE FOR SOLAR CONTROLLER

(71) Applicant: TAIZHOU TONGFENG PHOTOELECTRIC TECHNOLOGY CO., LTD, Taizhou (CN)

(72) Inventor: Yuqian Zhang, Taizhou (CN)

(73) Assignee: TAIZHOU TONGFENG PHOTOELECTRIC TECHNOLOGY CO., LTD, Taizhou (CN)

(21) Appl. No.: 19/441,779

(22) Filed: Jan. 6, 2026

(30) Foreign Application Priority Data
Jan. 10, 2025 (CN) 202520062853.1

(51) Int. Cl. H02S 40/34; H02G 3/08

(52) U.S. Cl. CPC H02S 40/34; H02G 3/086

(57) ABSTRACT

A connection structure for a solar controller is provided, which is more effortless and improves the assembling speed and quality. The key point of the technical solution is that the connection structure includes a housing and a fixed frame. An integrally connected connector rotatably connected to the fixed frame is arranged at one end of the housing. Rotating shafts are symmetrically arranged at two ends of an inner wall of the fixed frame. The connector is provided with a rotating slot matching the rotating shafts. Each rotating shaft is symmetrically provided with arc-shaped surfaces and flat surfaces. A convex block is arranged on one arc-shaped surface of the rotating shaft. A limiting slot matching the convex block is formed in each rotating slot. A clamping strip is further arranged at one end of the connector. A baffle plate matching the clamping strip is arranged inside the fixed frame.

### RELATED APPLICATIONS

The present patent document claims the benefit of priority to Patent Application No. 202520062853.1, filed Jan. 10, 2025, and entitled “CONNECTION STRUCTURE FOR SOLAR CONTROLLER,” the entire contents of each of which are incorporated herein by reference.

### BACKGROUND

### 1. Technical Field

The present disclosure relates to the technical field of solar controllers, and more specifically, to a connection structure for a solar controller.

### 2. Background Information

During traditional solar controller assembling, screw fixation, snap-in connection, and the like are often used. For screw fixation, a tool is required, and the screw fixation is time-consuming. The snap-in connection is prone to damage and requires high accuracy. In a production process of the solar controller, the traditional assembling manner often relies on many manual operations, which not only has low efficiency, but also are prone to manmade errors. This increases the production costs and the rate of rate of defective products. In large-scale production and on-site mounting, the efficiency is low, the labor intensity is high, and the product quality may be affected.

### BRIEF SUMMARY

For the shortcomings in the existing art, the present disclosure aims to provide a connection structure for a solar controller, which is more effortless and improves the assembling speed and quality.

In order to achieve the above objectives, the present disclosure provides the following technical solution: A connection structure for a solar controller includes a housing and a fixed frame. An integrally connected connector rotatably connected to the fixed frame is arranged at one end of the housing. Rotating shafts are symmetrically arranged at two ends of an inner wall of the fixed frame. The connector is provided with a rotating slot matching the rotating shafts. Each rotating shaft is symmetrically provided with arc-shaped surfaces and flat surfaces. A convex block is arranged on one arc-shaped surface of each rotating shaft. A limiting slot matching the convex block is formed in each rotating slot. A clamping strip is further arranged at one end of the connector. A baffle plate matching the clamping strip is arranged inside the fixed frame. The clamping strip is configured to form a supporting point of a force when the connector approaches the fixed frame along the flat surfaces of the rotating shafts and resists against the baffle plate through the clamping strip, and an acting force is then applied to the housing, to cause the rotating shafts to be snapped into the rotating slot to form rotatable connection. The baffle plate is configured to cause, when the housing and the fixed frame are rotated to a horizontal plane, the clamping strip and the baffle plate to resist against each other to limit turning.

In a further setting of the present disclosure, a height of an opening of the rotating slot is 0.9 times a diameter of each rotating shaft.

In a further setting of the present disclosure, a length of each rotating shaft is ½ to ⅔ of a diameter.

In a further setting of the present disclosure, a length of the clamping strips 0.75 to 0.9 times a length of the baffle plate.

In a further setting of the present disclosure, antiskid lines are arranged at a top and a bottom of an opening of the rotating slot.

In a further setting of the present disclosure, a plurality of reinforcing ribs are arranged between one side of the connector facing away from the rotating slot and the housing.

In a further setting of the present disclosure, rotation angles of the housing and the fixed frame are 0 to 100 degrees.

Beneficial effects of the present disclosure are as follows:

1. By the rotatable connection between the rotating shafts and the rotating slot, and the cooperation with the structures of the clamping strip and the baffle plate, an operator only needs to make the connector approach the fixed frame along the flat surfaces of the rotating shafts. The contact between the clamping strip and the baffle plate is used as a supporting point to apply a force. The rotating shafts can be easily snapped into the rotating slot based on the lever principle, to complete the rotatable connection. This greatly simplifies the assembling process, reduces the assembling time and the labor costs, and improves the production efficiency. Especially in large-scale production, the present disclosure has significant advantages. The arc-shaped surfaces and the flat surfaces that are symmetrically provided on the rotating shafts and the cooperation between the convex block and the limiting slot ensure the stability of the connection structure after assembling. In one aspect, this effectively prevents accidental loosening or displacement between the connector and the rotating shafts, and ensures the stability of relative positions of the components of the solar controller during long-term use. In another aspect, when the housing and the fixed frame are rotated to a horizontal plane, the clamping strip and the baffle plate resist against each other to limit turning, thus avoiding unnecessary rotation caused by an external force or vibrations, ensuring the stability and safety of equipment operation, lowering a risk of failure caused by loose connections, and improving the overall reliability and service life of the solar controller.

2. When the height of the opening of the rotating slot is less than 0.9 times the diameter of each rotating shaft, the opening is obstructed because it is too small during mounting. This may damage the connector or the fixed frame. When the height of the opening of the rotating slot is greater than 0.9 times the diameter of each rotating shaft, the opening cannot restrict the rotating shaft within the rotating slot because it is too large. This may damage the connection structure during rotation. Therefore, the height of the opening of the rotating slot is set to 0.9 times the diameter of each rotating shaft, so that the rotating shaft has a precision requirement when inserted into the rotating slot, and can play a good role in guiding. The rotating shaft can always maintain a good cooperation state during rotation in the rotating slot, which improves the stability of the overall connection structure and allows the solar controller to better cope with various vibrations, external forces, and other situations during use.

3. When the length of each rotating shaft is less than ½ of the diameter, the rotating shaft is too short, so that the force transferring is not balanced when the rotating shaft cooperates with the rotating slot. When the length of each rotating shaft is greater than ⅔ of the diameter, the rotating shaft is too long and will occupy a large space and increase the material costs. Therefore, the optimal length of each rotating shaft is between ½ and ⅔ of the diameter. An appropriate length range ensures that the force distribution of the rotating shaft is relatively uniform in the rotation process, so that an excessive local force caused by a significant cantilever effect because of the excessive length is avoided. When the length of the clamping strip is less than 0.75 times the length of the baffle plate, a sufficient limiting force cannot be provided, so that the housing may damage an internal structure and an electrical connection when turned. When the length of the clamping strip is greater than 0.9 times the length of the baffle plate, the clamping strip may resist against each rotating shaft during rotation, which affects the usage effect. Therefore, the optimal length of the clamping strip is between 0.75 and 0.9 times the length of the baffle plate, which can provide a sufficient contact area and resistance, and has feasibility and convenience in processing and manufacturing. The increase in the processing difficulty due to a large size difference between the clamping strip and the baffle plate is avoided, and it also helps to ensure the processing accuracy, reduce a manufacturing error, and improve the production efficiency and the product quality.

4. The antiskid lines are arranged at the top and the bottom of the opening of the rotating slot. When the rotating shafts are inserted into the rotating slot, the antiskid lines can increase the friction between the rotating shafts and the opening of the rotating slot. In an assembling process, the rotating shafts can be more stably placed at corresponding positions, and sliding, shifting, or the like due to an external force and another factor during operation are unlikely to occur. This helps an operator to more accurately complete the cooperative mounting of the rotating shafts and the rotating slot and improves the assembling success rate and efficiency. The reinforcing ribs are arranged between one side of the connector facing away from the rotating slot and the housing, so that the strength of connection between the connector and the housing is enhanced. The external force borne by the connector during use can be shared, and the rigidity and stability of the entire structure are improved.

### BRIEF DESCRIPTION OF THE DRAWINGS

FIG. 1 is a schematic diagram of a three-dimensional structure according to the present invention;

FIG. 2 is a schematic diagram of a three-dimensional structure of a housing; and

FIG. 3 is a schematic diagram of a three-dimensional structure of a fixed frame.

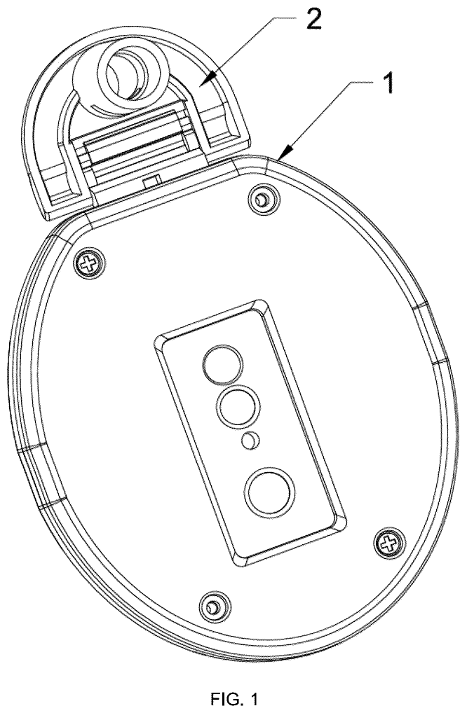

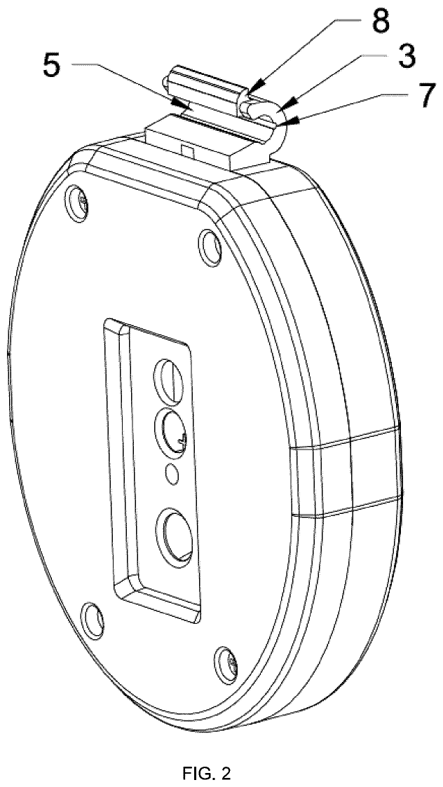

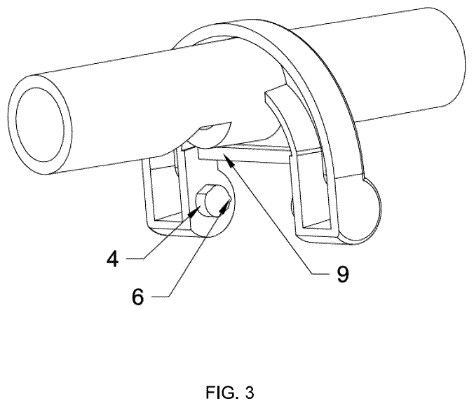

### REFERENCE NUMERALS IN FIG. 1 TO FIG. 3

1: housing; 2: fixed frame; 3: connector; 4: rotating shaft; 5: rotating slot; 6: convex block; 7: limiting slot; 8: clamping strip; and 9: baffle plate.

### DETAILED DESCRIPTION OF THE DRAWINGS AND THE PRESENTLY PREFERRED EMBODIMENTS

Referring to FIG. 1 to FIG. 3, a further explanation will be made to the embodiments of the present disclosure.

For ease of explanation, spatial relative terms such as “up”, “down”, “left”, and “right” are used in the embodiments to illustrate a relationship between one element or feature shown in the figures and another element or feature. It should be understood that in addition to the orientations shown in the figures, the spatial terms are intended to include different orientations of a device during use or operation. For example, if the device in the figures is placed upside down, an element described as being located “below” another element or feature will be positioned as being “above” the another element or feature. Therefore, the exemplary term “down” can include both up and down orientations. The device can be positioned in other ways (rotated 90 degrees or in other orientations), and the spatial relative explanations used here can be explained correspondingly.

Moreover, relational terms such as “first” and “second” are only used to distinguish one component from another with the same name, without necessarily requiring or implying any actual relationship or order between these components.

As shown in FIG. 1 to FIG. 3, a connection structure for a solar controller includes a housing 1 and a fixed frame 2. An integrally connected connector 3 rotatably connected to the fixed frame 2 is arranged at one end of the housing 1. Rotating shafts 4 are symmetrically arranged at two ends of an inner wall of the fixed frame 2. The connector 3 is provided with a rotating slot 5 matching the rotating shafts 4. Each rotating shaft 4 is symmetrically provided with arc-shaped surfaces and flat surfaces. A convex block 6 is arranged on one arc-shaped surface of each rotating shaft. A limiting slot 7 matching the convex block 6 is formed in the rotating slot 5. After assembling of the fixed frame 2 and the connector 3 is completed, and they are in an opened or stored state, the convex block 6 is located within the limiting slot 7 to form a limiting structure, so that rotation can be achieved only by a high force. A clamping strip 8 is further arranged at one end of the connector 3. A baffle plate 9 matching the clamping strip 8 is arranged inside the fixed frame 2. By the rotatable connection between the rotating shafts 4 and the rotating slot 5, and the cooperation with the structures of the clamping strip 8 and the baffle plate 9, an operator only needs to make the connector 3 approach the fixed frame 2 along the flat surfaces of the rotating shafts 4. The contact between the clamping strip 8 and the baffle plate 9 is used as a supporting point to apply a force. The rotating shafts 4 can be easily snapped into the rotating slot 5 based on the lever principle, to complete the rotatable connection. This greatly simplifies the assembling process, reduces the assembling time and the labor costs, and improves the production efficiency. Especially in large-scale production, the present disclosure has significant advantages. The arc-shaped surfaces and the flat surfaces that are symmetrically provided on the rotating shafts 4 and the cooperation between the convex block 6 and the limiting slot 7 ensure the stability of the connection structure after assembling. In one aspect, this effectively prevents accidental loosening or displacement between the connector 3 and the rotating shafts 4, and ensures the stability of relative positions of the components of the solar controller during long-term use. In another aspect, when the housing 1 and the fixed frame 2 are rotated to a horizontal plane, the clamping strip 8 and the baffle plate 9 resist against each other to limit turning, thus avoiding unnecessary rotation caused by an external force or vibrations, ensuring the stability and safety of equipment operation, lowering a risk of failure caused by loose connections, and improving the overall reliability and service life of the solar controller.

When the height of the opening of the rotating slot 5 is less than 0.9 times the diameter of each rotating shaft 4, the opening is obstructed because it is too small during mounting. This may damage the connector 3 or the fixed frame 2. When the height of the opening of the rotating slot 5 is greater than 0.9 times the diameter of each rotating shaft 4, the opening cannot restrict the rotating shaft 4 within the rotating slot 5 because it is too large. This may damage the connection structure during rotation. Therefore, the height of the opening of the rotating slot 5 is set to 0.9 times the diameter of each rotating shaft 4, so that the rotating shaft 4 has a precision requirement when inserted into the rotating slot 5, and can play a good role in guiding. The rotating shaft 4 can always maintain a good cooperation state during rotation in the rotating slot 5, which improves the stability of the overall connection structure and allows the solar controller to better cope with various vibrations, external forces, and other situations during use.

When the length of each rotating shaft 4 is less than ½ of the diameter, the rotating shaft 4 is too short, so that the force transferring is not balanced when the rotating shaft 4 cooperates with the rotating slot 5. When the length of each rotating shaft 4 is greater than ⅔ of the diameter, the rotating shaft 4 is too long and will occupy a large space and increase the material costs. Therefore, the optimal length of each rotating shaft 4 is between ½ and ⅔ of the diameter. An appropriate length range ensures that the force distribution of the rotating shaft 4 is relatively uniform in the rotation process, so that an excessive local force caused by a significant cantilever effect because of the excessive length is avoided.

When the length of the clamping strip 8 is less than 0.75 times the length of the baffle plate 9, a sufficient limiting force cannot be provided, so that the housing 1 may damage an internal structure and an electrical connection when turned. When the length of the clamping strip 8 is greater than 0.9 times the length of the baffle plate 9, the clamping strip 8 may resist against each rotating shaft 4 during rotation, which affects the usage effect. Therefore, the optimal length of the clamping strip 8 is between 0.75 and 0.9 times the length of the baffle plate 9, which can provide a sufficient contact area and resistance, and has feasibility and convenience in processing and manufacturing. The increase in the processing difficulty due to a large size difference between the clamping strip 8 and the baffle plate 9 is avoided, and it also helps to ensure the processing accuracy, reduce a manufacturing error, and improve the production efficiency and the product quality.

Antiskid lines are arranged at a top and a bottom of the opening of the rotating slot 5. When the rotating shafts 4 are inserted into the rotating slot 5, the antiskid lines can increase the friction between the rotating shafts 4 and the opening of the rotating slot 5. In an assembling process, the rotating shafts 4 can be more stably placed at corresponding positions, and sliding, shifting, or the like due to an external force and another factor during operation are unlikely to occur. This helps an operator to more accurately complete the cooperative mounting of the rotating shafts 4 and the rotating slot 5 and improves the assembling success rate and efficiency.

A plurality of reinforcing ribs are arranged between one side of the connector 3 facing away from the rotating slot 5 and the housing 1, so that the strength of connection between the connector 3 and the housing 1 is enhanced. The external force borne by the connector 3 during use can be shared, and the rigidity and stability of the entire structure are improved.

Rotation angles of the housing 1 and the fixed frame 2 are 0 to 100 degrees. This facilitates folding and storage. To use the product, they can be quickly opened. When the fixed frame 2 is inserted into the connector 3 in a 30-degree direction, and an acting force is applied to the housing 1, the rotating shafts 4 are snapped into the rotating slot 5 to form rotatable connection. An optimal angle is 91 degrees. The excess one degree is conductive to discharging water accumulated at connection positions.

The above-mentioned embodiments are only preferred embodiments of the present disclosure and are not intended to limit the present disclosure, and the usual changes and substitutions made by those skilled in the art within the scopes of the technical solutions of the present disclosure shall fall within the protection scope of the present disclosure.

1. A connection structure for a solar controller, comprising a housing (1) and a fixed frame (2), wherein an integrally connected connector (3) rotatably connected to the fixed frame (2) is arranged at one end of the housing (1); rotating shafts (4) are symmetrically arranged at two ends of an inner wall of the fixed frame (2); the connector (3) is provided with a rotating slot (5) matching the rotating shafts (4); each rotating shaft (4) is symmetrically provided with arc-shaped surfaces and flat surfaces; a convex block (6) is arranged on one arc-shaped surface of each rotating shaft; a limiting slot (7) matching the convex block (6) is formed in the rotating slot (5); a clamping strip (8) is further arranged at one end of the connector (3); a baffle plate (9) matching the clamping strip (8) is arranged inside the fixed frame (2); the clamping strip (8) is configured to form a supporting point of a force when the connector (3) approaches the fixed frame (2) along the flat surfaces of the rotating shafts (4) and resists against the baffle plate (9) through the clamping strip (8), and an acting force is then applied to the housing (1), to cause the rotating shafts (4) to be snapped into the rotating slot (5) to form rotatable connection; and the baffle plate (9) is configured to cause, when the housing (1) and the fixed frame (2) are rotated to a horizontal plane, the clamping strip (8) and the baffle plate (9) to resist against each other to limit turning.

2. The connection structure for the solar controller according to claim 1, wherein a height of an opening of the rotating slot (5) is 0.9 times a diameter of each rotating shaft (4).

3. The connection structure for the solar controller according to claim 1, wherein a length of each rotating shaft (4) is ½ to ⅔ of a diameter.

4. The connection structure for the solar controller according to claim 1, wherein a length of the clamping strip (8) is 0.75 to 0.9 times a length of the baffle plate (9).

5. The connection structure for the solar controller according to claim 1, wherein antiskid lines are arranged at a top and a bottom of an opening of the rotating slot (5).

6. The connection structure for the solar controller according to claim 1, wherein a plurality of reinforcing ribs are arranged between one side of the connector (3) facing away from the rotating slot (5) and the housing (1).

7. The connection structure for the solar controller according to claim 1, wherein rotation angles of the housing (1) and the fixed frame (2) are 0 to 100 degrees.
